(19) United States
(12) Patent Application Publication
(10) Pub. No.: US 2026/0141630 A1
(43) Pub. Date: May 21, 2026

(54) THREE-DIMENSIONAL MODELING OF SATELLITES FROM SATELLITE IMAGERY

(71) Applicant: BAE SYSTEMS Information and Electronic Systems Integration Inc., Nashua, NH (US)

(72) Inventor: Reuben J. Settergren, Poway, CA (US)

(73) Assignee: BAE SYSTEMS Information and Electronic Systems Integration Inc., Nashua, NH (US)

(21) Appl. No.: 18/951,945

(22) Filed: Nov. 19, 2024

(51) Int. Cl. G06T 17/00; G06T 7/70

(52) U.S. Cl. CPC G06T 17/00; G06T 7/70; G06T 2207/30244

(57) ABSTRACT

A method of modeling three-dimensional objects from two-dimensional imagery includes receiving, from an imaging device with a sensor, one or more digital images of an object and image metadata representing a focal length of the sensor, a pixel size of the sensor, and a range of each of the one or more digital images; adding, to the one or more digital images, digital markings representing perpendicular axes of the object; computing at least one sensor model of the imaging device based on the image metadata, the digital markings, and the perpendicular axes of the object; computing object-space coordinates of points corresponding to different features of the object based on the at least one sensor model; and generating a three-dimensional model of the object based on the object-space coordinates of the points.

### FIELD OF DISCLOSURE

The present disclosure relates to mensuration of three-dimensional objects from two-dimensional imagery, and more particularly, to techniques for three-dimensional modelling of satellites from satellite imagery.

### BACKGROUND

Three-dimensional (3-D) objects observed in two-dimensional (2-D) imagery can be measured and modeled using photogrammetry techniques. Certain techniques measure observable features of the object based on the precise position and orientation of the observer (e.g., a camera). For instance, if the scene in which the object appears is imaged from two or more different perspectives, the changes in the apparent shape of the object between the perspectives can be used to measure the observable features of the object if the position and the orientation of the camera relative to the scene is known. However, if objects change position in the scene as the camera concurrently changes position or range, these techniques may produce incorrect measurements. Therefore, non-trivial issues remain with respect mensuration using photogrammetry.

### BRIEF DESCRIPTION OF THE DRAWINGS

FIG. 1 is a schematic diagram of a photogrammetric system environment with an imaging platform, in accordance with an example of the present disclosure.

FIG. 2 is a block diagram of the imaging platform of FIG. 1, in accordance with an example of the present disclosure.

FIG. 3 depicts a property of linear perspective in an image acquired using the imaging platform of FIGS. 1 and 2, in accordance with an example of the present disclosure.

FIG. 4 shows an image of various features of an observed object of the environment of FIG. 1, in accordance with an example of the present disclosure.

FIG. 5 shows markings of the features of FIG. 4, in accordance with an example of the present disclosure.

FIGS. 6-7 show the markings of the features of FIG. 5, vector-summed and unitized, in accordance with an example of the present disclosure.

FIG. 8 is a graph of a projection geometry with R-solvable zones for XZ angle, given XY angle, in accordance with an example of the present disclosure.

FIG. 9 is an ambiguous collection perspective of a building, in accordance with an example of the present disclosure.

FIG. 10 is a perspective image of an object, in accordance with an example of the present disclosure.

FIG. 11 is a flow diagram of a method of modeling three-dimensional objects from two-dimensional imagery, in accordance with an example of the present disclosure.

FIG. 12 is a flow diagram of a method of modeling three-dimensional objects from two-dimensional imagery, in accordance with another example of the present disclosure.

FIG. 13 is a flow diagram of the method of FIG. 11 in further detail, in accordance with another example of the present disclosure.

FIG. 14 is a flow diagram of the method of FIG. 11 in further detail, in accordance with further examples of the present disclosure.

Although the following detailed description refers to illustrative examples, many alternatives, modifications, and variations thereof will be apparent in light of this disclosure.

### DETAILED DESCRIPTION

Techniques for modeling three-dimensional objects from two-dimensional imagery are disclosed. The disclosed techniques are particularly useful for medium-range and long-range non-earth imaging of objects in space, but also may be used for other observable objects in motion. As orbiting platforms with imaging sensors pass within visual range of other objects, the sensors capture one or more digital images of the objects. These images, individually or in combination, can be analyzed to obtain information about the objects, including measurements of various visible features. In turn, the measurements can be used to create three-dimensional models of the object, or at least observable portions of the object, which are useful for various tasks, such as space domain awareness. Such tasks are performed using the space-based sensors, which can observe objects that are not easily or readily visible from the surface of the Earth or from the lower Earth atmosphere.

As described above, measuring features of an object can be accomplished by a system that is configured to image the object from one or more perspectives, where the apparent shape of the object can be used to measure the observable features of the object if the position and the orientation of the camera relative to the scene is known. However, such a system (e.g., an Earth-based imaging platform) may produce incorrect measurements, particularly when the object changes position and orientation in the scene as the camera concurrently changes position and range.

To this end, the techniques described herein can be used to improve the system accuracy for space-based imaging applications, such as when the object and/or camera(s) are in motion and the imaging occurs at medium- to long-range. As described in further detail below, medium- to long-range refers to a linear perspective where lines projected parallel to features (e.g., edges) of an object in the image do not converge at any vanishing points, but rather project nearly (apparently) parallel to each other. That is, in medium to long range imagery, the vanishing points of the object-parallel lines are so far outside the bounds of the image that the line segments within the image are practically parallel within subpixel accuracy.

In an example of the present disclosure, a method includes receiving, by one or more processors and from an imaging device, one or more digital images of an object and image metadata representing the focal length of the sensor, the pixel size of the sensor, and the range (distance from sensor to object) of each image. Note that the range can be roughly estimated and refined if the length of a feature on the object is known, to establish scale. The method further includes adding, to the one or more digital images, digital markings of the perpendicular axes of the object, also referred to as the object coordinate system. The method further includes computing at least one sensor model of the imaging device based on the image data, the markings, and the three-dimensional axes associated with the object. The method further includes computing object-space coordinates of points corresponding to at least one of the different features of the object based on the sensor model. The method further includes generating a three-dimensional model of the object based on the object-space coordinates of the points. In some examples, the three-dimensional model of the object can be rendered or otherwise displayed via a display device, or provided for further processing, such as for object identification, space domain awareness or characterization, mission planning, repair and maintenance, inspection, damage assessment, engineering reviews, or other purposes.

### Example Photogrammetric System Environment

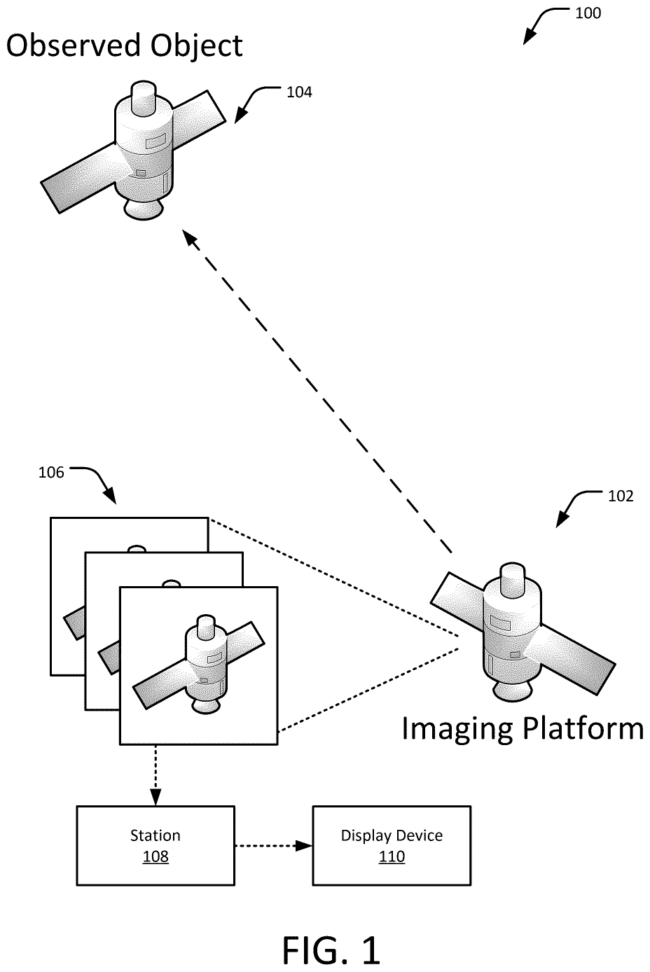

FIG. 1 is a schematic diagram of a photogrammetric system environment 100, in accordance with an example of the present disclosure. The environment 100 includes one or more imaging platforms 102 and an observed object 104. Each imaging platform 102 can be, for example, an orbiting satellite, and the observed object 104 can be another orbiting satellite, an airborne object, or any other object that can be observed from the imaging platform 102. Each imaging platform 102 is configured to acquire digital imagery 106 of the observed object 104. The digital imagery 106 can be transmitted or otherwise communicated to a station 108 (ground, airborne, marine, or space) for further processing, including, for example generating three-dimensional image data of the observed object 104 based on the digital imagery 106, and causing the three-dimensional image data of the observed object 104 to be displayed on a display device 110, such as a three-dimensional image projector with separate left and right eye displays for 3-D viewing of a machine-generated model of the observed object 104.

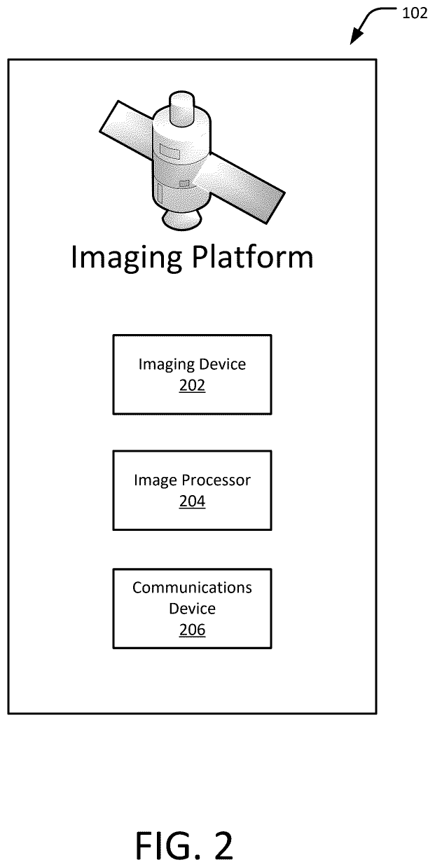

FIG. 2 is a block diagram of the imaging platform 102 of FIG. 1, in accordance with an example of the present disclosure. The imaging platform 102 includes at least one imaging device 202, such as a digital camera with an imaging sensor. The imaging platform 102 further includes an image processor 204 configured to process signals acquired from the imaging device 202, for example, to convert the output of the imaging device 202 into data that can be transmitted off-board for further processing (e.g., by the station 108). The imaging platform 102 further includes a communications device 206, such as a radio transmitter, configured to transmit the data from the image processor 204 to the station 108.

Generally, the techniques disclosed herein can be used for photogrammetric analysis of the digital imagery 106 of the observed object 104. More particularly, the disclosed techniques are useful for mensuration of features of the observed object 104, or at least portions of the observed object 104, that are observable from the imaging platform 102 at medium- or long-range. Measurements of these features can, in turn, be used for photogrammetric reconstruction of three-dimensional models, feature data, and observation data representing the observed object 104, which are useful for various applications such as Space Domain Awareness.

In more detail, the digital imagery 106, obtained with one or more imaging devices 202 such as a digital camera, can be used to determine the dimensions and relative positions of various points on the surface of the observed object 104. Although each image of the digital imagery 106 is a digitized two-dimensional representation of the observed object 104, a 3-D model of the observed object 104 can be reconstructed from the image(s) if given a sufficient amount of information about the imaging device 202, such as pixel size, focal length, and range, using the analysis detailed in this disclosure. Such a 3-D model can represent the size and shape of the observed object 104, which in turn can be used to identify characteristics of other objects in the scene, such as the height of antenna mounted to a reference platform, accounting for the perspective of the imaging device 202.

Some 3-D reconstruction techniques utilize a large number of calibrated data points. For example, two or more images that have overlapping scenes and identical optical distances, but different perspectives (e.g., stereoscopy), can be used to calculate certain characteristics of an object that appears in each of the images. However, such techniques include assumptions that the content of the 3-D scene must remain stationary while the camera is moved to different positions and orientations, relative to the fixed scene, to acquire images from different perspectives. This assumption is violated if the observed object is moving while the camera is being moved to different positions and orientations.

Thus, such 3-D reconstruction techniques are inadequate when these assumptions are false, such as when an object in the scene is moving and/or rotating between the time successive images are acquired. This is particularly true for long- and medium-range imagery. For example, if the object is an Earth-orbiting satellite, the satellite may be moving toward or away from a camera on another satellite or orbiting platform, causing features of the imaged satellite to appear larger or smaller in a series of sequentially obtained images. If the speed and/or rotation of the satellite relative to the camera is not known, it can be difficult to accurately account for the change in the apparent size and relative motion or rotation of the satellite when attempting to reconstruct a 3-D model of the satellite from the series of images. For instance, when both the camera and the object are moving, simple translation of the image geometry is insufficient. Rather, in accordance with an example of the present disclosure, the geometry of the camera must be rotated to a common coordinate system anchored to the body of the object, such as described in further detail below.

In another example, it can be difficult to reconstruct the 3-D model of the object if the images of the object are acquired from cameras on different satellites whose relative positions are unknown. Thus, there are non-trivial issues with respect to mensuration of satellites or other objects from satellite imagery, and more particularly, from long-range imagery.

In addition to challenges for stereoscopy when the object is not stationary, even for monoscopic exploitation, mensuration is problematic when the object is imaged at an arbitrary/diagonal pose. Scaling the pixel size using focal length and range does not yield correct lengths on the object because true diagonal lengths on the object are longer than apparent in the pixels. How much longer the lengths are depends on how diagonal the pose is, which is not known. For maximum utility and accuracy, the sensor model for each image is created relative to a coordinate system fixed to the body of the object.

To this end, examples of the present disclosure use one or more digital images (e.g., the digital imagery 106) for mensuration and modelling of features on a satellite or other rigid object (e.g., the observed object 106), which is observed at long range. The digital imagery 106 does not need to be from the same imaging platform 102 (e.g., satellite). A sensor model for each imaging device 202 treats the axes of the observed object 106 as a fixed reference (coordinate system). The sensor model virtually repositions the camera (e.g., rotation, range, and translation) to a pose defined in the fixed coordinate system of the observed object 104. The sensor model for a single image supports a variety of monoscopic measurements of object features, such as lengths and angles. Sensor models for two or more images enables full stereoscopic measurements, where the 3-D coordinates of every observable point of the observed object 104 in all of the digital imagery 106 can be determined from the model. The 3-D coordinates can in turn provide a 3-D reconstruction of the observed object 104 and stereoscopic viewing of the observed object 104 for visual assessment, among other things.

More particularly, techniques are disclosed for synthesizing sensor models for long- or medium-range imagery. Inputs to the model are focal length, pixel size, range, digital image markings of a user-selected object-space origin, and lines on the body of the object that are observable in the image(s) and known/assumed to be parallel to the 3-D perpendicular axes of the body. An important property of linear perspective at long and medium ranges is that projected object-parallel lines do not converge at any vanishing points, but rather project nearly (apparently) parallel to each other. That is, the vanishing points are so far outside the bounds of the image that the line segments within the image are practically parallel within subpixel accuracy. The slopes of each axis in the imagery relative to the 3-D coordinate system of the object are defined by a unique rotation matrix of the camera. After establishing the rotation of the camera, the position of the camera is determined by virtually backing the rotated camera away from the object, up to a known range with respect to the object. Finally, the camera is translated parallel to the focal plane to align the object coordinate (0, 0, 0) with a user-selected origin within the digital image. After the sensor models are synthesized for one or more images, photogrammetric techniques can be used to measure the object monoscopically or stereoscopically, depending on the number of images available from different perspectives.

### Mensuration of Objects Using Long-Range Sensor Models

In accordance with an example of the present disclosure, techniques are disclosed for reconstruction of a 3-D model of an object (e.g., the observed object 104) from multiple two-dimensional (2-D) images of the object taken from different perspectives, and more particularly, for mensuration of satellites from satellite imagery. The disclosed techniques take advantage of several properties of linear perspective to synthesize one or more long-range sensor models (also referred to as camera matrices). As used in this disclosure, a camera matrix is a 3×4 matrix which projects 3-D object coordinates into 2-D pixel coordinates. 3-D coordinates must be augmented to 4-D by concatenating a homographic scale of 1; after multiplying the 3×4 camera matrix by the 4×1 object coordinate, the result is a 3×1 image coordinate [x; y; w]. The third dimension w is also a homographic scale, and the pixel coordinates can be obtained as [x/w; y/w], which can then be exploited using photogrammetric/computer vision techniques to obtain measurements of the object appearing in one or more 2-D images of 3-D scenes obtained from the camera(s). For example, linear perspective can be used to represent a three-dimensional scene in two-dimensions, such as in a 2-D photograph of a 3-D scene. A sensor model for a single image supports monoscopic measurements of objects, such as lengths and angles even for structures not parallel to the imaging focal place if the alignment of the structures to a coordinate system anchored to the object is known or assumed. A sensor model for multiple images supports stereoscopic measurements of the object using the three-dimensional coordinates of every point on the object that is observable in every image.

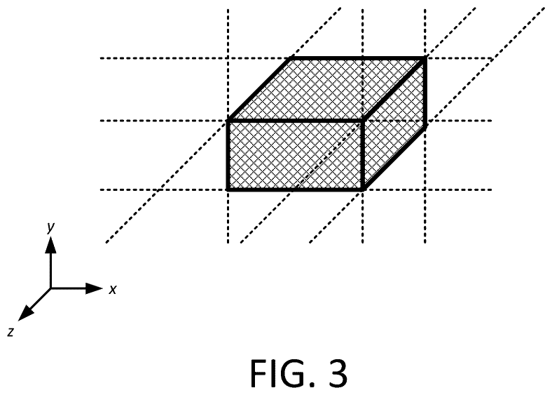

FIG. 3 depicts a property of linear perspective, where straight lines in a 3-D scene appear straight in a 2-D perspective view of the scene (e.g., a photograph). Another property of linear perspective is that, depending on the camera orientation and range, parallel lines in the scene are parallel in the view, or, if non-parallel, the lines converge at a vanishing point. The vanishing point is a point where the parallel lines in the 2-D perspective view intersect. Depending on camera orientation and range, the vanishing point may be outside of the view. Yet another property of linear perspective is that the apparent size of the object in the scene is linearly proportional to the distance of the object from the observer (e.g., a camera or other imaging device). Analysis of vanishing points, if any, or slopes of parallel lines, can be used to recover the position, pose, and calibration of the camera, which in turn can be used to calculate the dimensions of the object for reconstructing the 3-D model.

The perspective view may exhibit three, two, one, or zero vanishing points, depending on range and orientation of the camera. For example, a close-range camera with principal ray not perpendicular to any ground axis exhibits a three-point perspective (3PP) view, with three vanishing points (none of the ground dimensions appear to be parallel). A two-point perspective (2PP) view results from a close-range camera with line of sight perpendicular to one ground axis, and has two vanishing points where one of the ground dimensions appears to be parallel (for instance, where the camera is pointed level (perpendicular to vertical), and vertical lines are parallel in the image). A one-point perspective (1PP) view has one vanishing point where two of the ground dimensions appear to be parallel. A long-range perspective view has no vanishing points as all three ground dimensions appear to be parallel or nearly parallel due to the great distance between the object and the camera and the long focal length, such as shown in FIG. 3.

For an image of an object (e.g., a satellite in orbit), features of the object, such as an edge of the object, can be digitally marked in the image with respect to (e.g., parallel to) a 3-D axis associated with the object. For example, each feature can be digitally marked with a unique label (such as color) for each axis, such as red lines for features parallel to an image-rightward axis (x-axis), green lines for features parallel to an image-upward axis (y-axis), and blue lines for features parallel to an image-outward axis (z-axis, toward viewer).

### Sensor Model

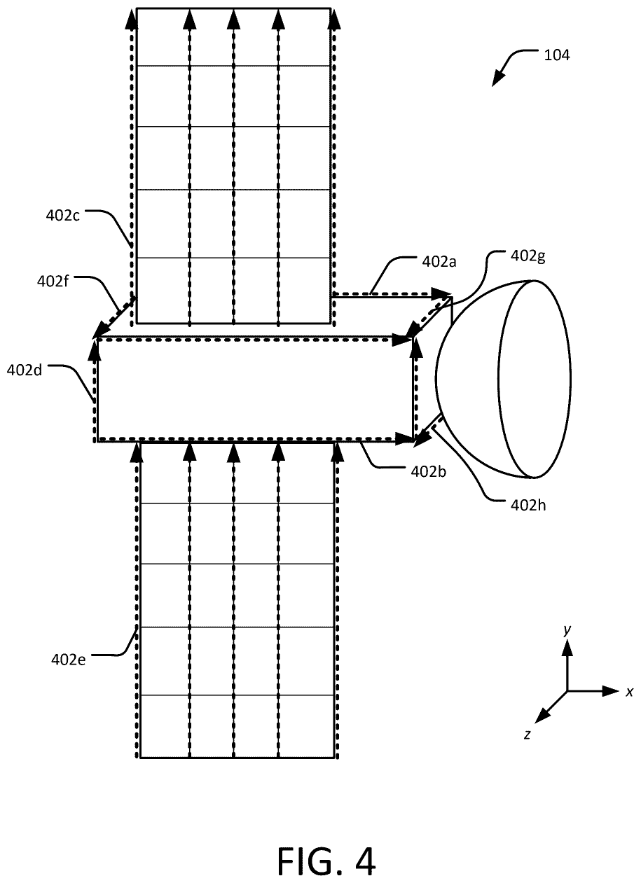

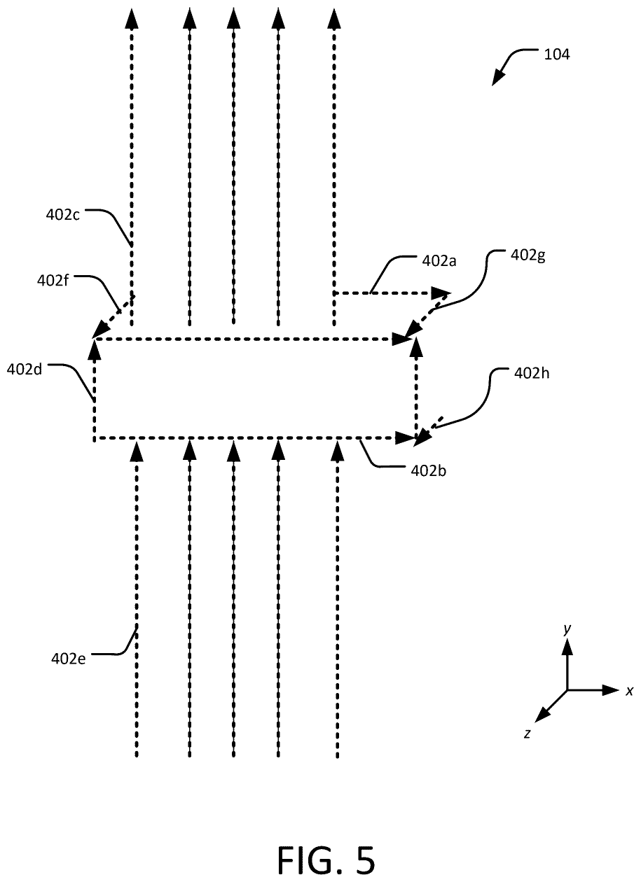

FIG. 4 shows an image of various features of the observed object 104, in accordance with an example of the present disclosure. The features can be marked, such as indicated along dashed lines 402a through 402g. For clarity, not all of the dashed lines in FIG. 4 are labeled; however, it will be understood that any features of the observed object 104 can be marked if they are known to be linear and perpendicular to the three-dimensional axis. For example, in FIG. 4, lines 402a-b are in the x-direction, lines 402c-e are in the y-direction, and line 402f-h are in the z-direction. Other parallel lines can be similarly marked in their respective directions. Features that are not known to be linear and perpendicular are not marked. However, in some examples, cylindrical features of the observed object 104 may be marked, such as described in further detail below. FIG. 5 shows the lines 402a . . . 402h with the observed object 104 removed for clarity.

Assuming there is no significant lens distortion, the image projection can be represented as a sensor model, or camera matrix, with a very large focal length and range, such as follows.

$$[ \begin{matrix}x \\ y \\ w\end{matrix} ] = [ \begin{matrix}f & 0 & {c}_{x} \\ 0 & f & {c}_{y} \\ 0 & 0 & 1\end{matrix} ] [ \begin{matrix} & & & {t}_{X} \\ {R}_{X} & {R}_{Y} & {R}_{Z} & {t}_{Y} \\ & & & {t}_{Z}\end{matrix} ] [ \begin{matrix}X \\ Y \\ Z \\ 1\end{matrix} ]$$

Where x/w and y/w are the 2-D output image coordinates of the camera, f is the focal ratio of the camera in units of pixels (the ratio between the physical focal length and the size of an individual pixel on the focal plane), and cₓ and c_{y} are the coordinates of the principal point (where the image ray is perpendicular to the focal plane). The principal point is defined as the point on the focal plane where an imaging ray is perpendicular and not angled outwards.

Because of the long-range collection, all imaging rays for pixels in the image are practically parallel, so without loss of generality the principal point can be taken to be the center of the image. The pose or exterior orientation of the camera is represented by a rotation-translation matrix, where columns R_{X}, R_{Y}, and R_{Z} are the rotation, t_{X} and t_{Y} is the translation of the camera in the focal plane, and t_{Z} is the range (alternately referred to as r). X, Y, and Z are the 3-D input image coordinates of the object in the coordinate system that is anchored to the object (the 4^{th} dimension 1 is the homographic scale component). In this disclosure, the focal ratio (focal length and pixel size) and range are assumed to be known. The principal point is assumed to be at the center of the image. The rotation and horizontal translation are solved for. The actual 2-D image coordinate to which the object coordinate projects is (x/w, y/w), where w>0 for all points in front of the camera (except for the camera center, where w=0). Points behind the camera yield w<0.

### Rotation-Translation

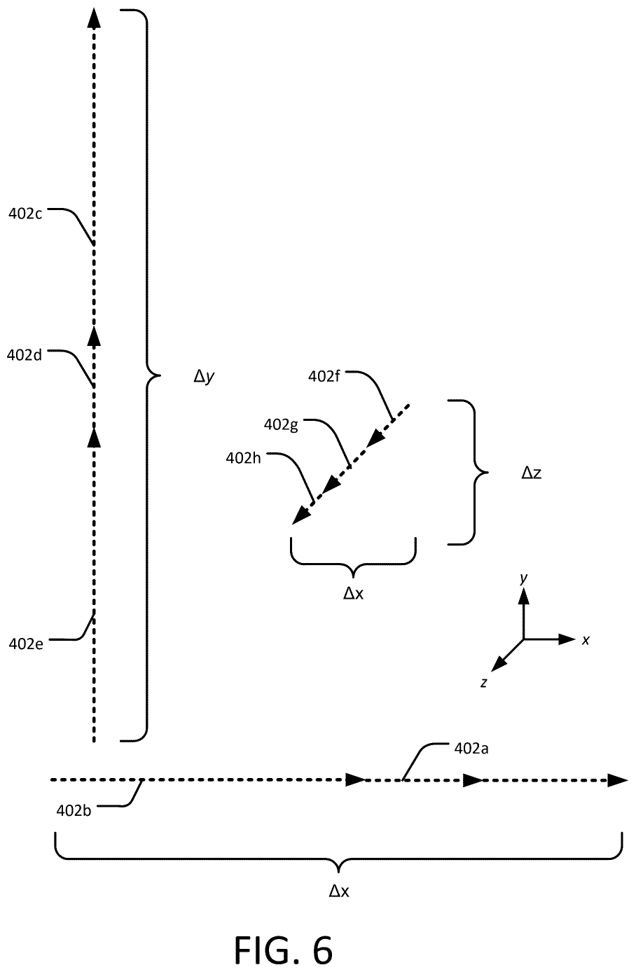

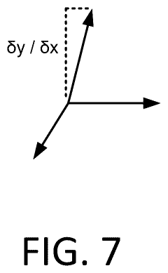

Using the long-range perspective view, the lines (e.g., dashed lines 402a . . . 402f) along each axis are parallel and can be stacked and unitized, such as shown in FIG. 6. For example, FIG. 6 shows at least some of the summed vectors for the x-axis, the y-axis, and the z-axis. The stacked and unitized lines for each axis can be summarized as a single ratio (slope δy/δx for each axis), such as shown in FIG. 7. The ratio δy/δx of two rotation matrix elements, e.g., R_{XY}/R_{XX}, can be determined from a projection of the origin and a point along a given axis. Each marked vector for an axis is an (imperfect) estimate of the true parallel image direction (slope) at which that axis projects into the image. The summation of all marked vectors is a more accurate estimate of that parallel direction than any of the individual vectors. Longer vectors naturally (and properly) contribute a higher weight to the estimate of slope provided by the summed vector.

$$[ \begin{matrix}f & 0 & 0 \\ 0 & f & 0 \\ 0 & 0 & 1\end{matrix} ] [ \begin{matrix} & & & 0 \\ {R}_{X} & {R}_{Y} & {R}_{Z} & 0 \\ & & & r\end{matrix} ] [ \begin{matrix}0 \\ 0 \\ 0 \\ 1\end{matrix} ] = [ \begin{matrix}0 \\ 0 \\ 1\end{matrix} ] \sim [ \begin{matrix}0 \\ 0\end{matrix} ] \frac{{R}_{XY}}{{R}_{XX}} = \frac{{δ}_{Y}}{{δ}_{X}}$$

$$[ \begin{matrix}f & 0 & 0 \\ 0 & f & 0 \\ 0 & 0 & 1\end{matrix} ] [ \begin{matrix}\begin{matrix}{R}_{XX} \\ {R}_{XY} \\ {R}_{XZ}\end{matrix} & {R}_{Y} & {R}_{Z} & \begin{matrix}0 \\ 0 \\ r\end{matrix}\end{matrix} ] [ \begin{matrix}1 \\ 0 \\ 0 \\ 1\end{matrix} ] = [ \begin{matrix}{fR}_{XX} \\ {fR}_{XY} \\ {R}_{XZ} + r\end{matrix} ] \sim \frac{f}{{R}_{XZ} + r} [ \begin{matrix}{R}_{XX} \\ {R}_{XY}\end{matrix} ]$$

The first two rows of the rotation matrix are assumed to have ratios that match the observed slopes for each axis.

$$R = [ \begin{matrix}δ x & δ x & δ x \\ δ y & δ y & δ y \\ a & b & c\end{matrix} ]$$

The properties of orthogonal matrices permit solving for the missing elements of the rotation matrix R that describes the observed set of slopes of projected X/Y/Z lines, where the dot product of each row is equal to one and the dot product of each column is zero (orthogonality constraints). Once the rotation matrix R is solved, the horizontal components of the translation can be solved. Zero translation (tₓ=0, t_{y}=0) projects the object origin onto the principal point (e.g., the center of the image), while non-zero translation (tₓ≠0 and/or t_{y}≠0) projects the object origin into any desired image coordinates.

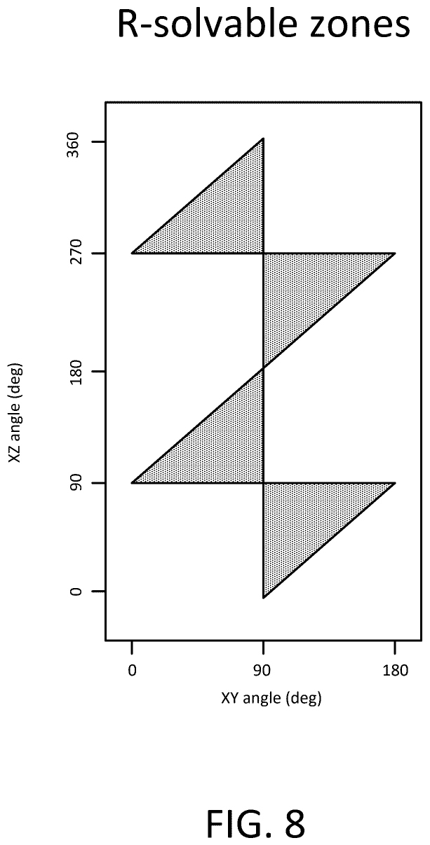

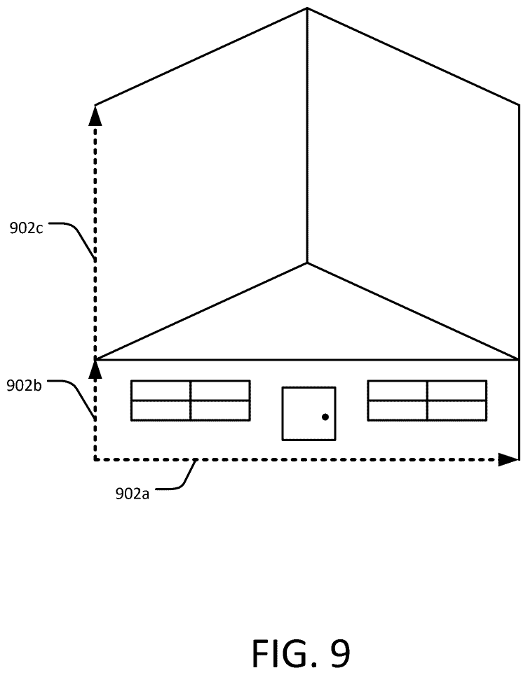

It will be understood that some projection geometries are impossible, such as projected axes in the image that can only be perspective views of non-orthogonal object axes; or a perspective view could be ambiguous, such as where two axes are parallel and thus indistinguishable from each other. For example, FIG. 8 shows R-solvable zones for XZ angle, given XY angle, where the zones are the shaded regions. Non-shaded regions are unsolvable, and imply that axes were marked erroneously, or the chosen features are not truly perpendicular on the object. In another example, FIG. 9 shows an ambiguous collection perspective of a building, with an observed X axis 902a, Y (vertical building edge) axis 902b, and Z (roofline) axis 902c. The Y and Z axes 902b and 902c are parallel in image-space. The building could have windows that are tall or wide or square; however, due to the perspective, it is not possible to distinguish the height and depth of the building because the Y and Z axes appear to be parallel.

Nevertheless, if a feature in perspective has a known or assumed shape (e.g., a circle appearing as an ellipse in perspective), tangents and chords can be used to solve the camera matrix for one axis. For example, the solved camera matrix can be used to measure lengths of object features along a given axis.

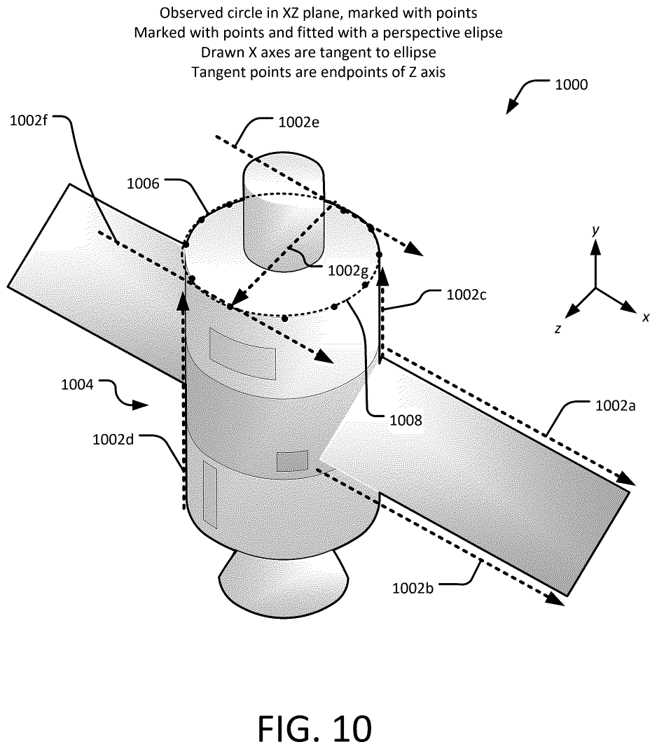

FIG. 10 shows an example of a perspective image of an object 1000, in accordance with an example of the present disclosure. The object 1000 includes straight edges that can be marked along, for example, the X axis (e.g., lines 1002a and 1002b) and the Y axis (e.g., lines 1002c and 1002d). If the object 1000 does not display three clear perpendicular axes, but all or part of a (known/assumed) circle is visible which lies in the plane of the missing axis (e.g., the Z axis) and one known axis (e.g., the X axis), then the following method recovers the missing axis.

For instance, referring to FIG. 10, assume a cylindrical object 1004 with visible X and Y axes, and a circular profile in the XZ plane. In perspective, all circles project as ellipses. An observed ellipse 1006 is marked, or marked with points around all or part of the observed ellipse 1006 to determine a fitted ellipse 1008 (indicated with a dashed line coincident with the observed ellipse 1006) through the points. For each marked X vector 1002e, 1002f, the vector is translated to be tangent to either side of the fitted ellipse 1008. A chord 1002g is created across the fitted ellipse 1008 between the tangent points of the vectors 1002e, 1002f. The chord is a Z vector. The ellipse process can be repeated for each marked X vector: each marked X vector (e.g., 1002e, 1002f) yields a chord that estimates a Z vector. All of the chords are then stacked and unitized, such as described. This process generalizes to the circular element of the object being in any principal plane, and recovering the missing axis via tangent points with vectors of the other axis of the plane. Note that this process also works if only one axis is clearly visible and there is a circle (perspective ellipse) in the plane of the other two axes, with a point on the circumference which is identifiable in all images. In this case, one missing axis is set to be the tangent vector to the ellipse at the identifiable point. Then translate the tangent vector to the other side of the ellipse to determine the opposite tangent point, and the final missing axis is the chord across the ellipse. Further note that once a chord across the ellipse is determined, the sign of the vector along that cord is not directly recoverable. The direction to orient the recovered chord(s) must be chosen by the user (e.g., choose from two slopes which are 180 degrees from each other).

### Scale

Range, focal length, and pixel size each linearly affect the scale of measurement using the sensor model. For a precisely calibrated sensor, the focal length and the pixel size are likely known precisely. Furthermore, the trajectory of the sensing platform on which the sensor resides may be known with greater precision than the trajectory of the target object, presuming that the camera is at least oriented toward the target object. Therefore, the principal source of error is uncertainty of the range to target.

If the size of the observed object is known (e.g., the length of a feature from the origin of the object coordinate system to a point along the X-axis) is s meters, then the solved sensor model can be used to project a point on the object (s, 0, 0) into the image space. If the projected image coordinate is exactly on the point that is known to be s meters from the origin, then the scale is correct. However, if the desired point is p pixels from the origin and the projected point is p′ pixels from the origin, then the scale is incorrect by a factor of p/p′. Correcting the range by a factor of p/p′ and re-solving the sensor model will cause the object coordinate (s, 0, 0) to project in the correct location. This scale correction works not just for the X-axis, but for any length in the XY plane.

If the size of the observed object is unknown and two or more images are exploited using stereoscopy, the scales of each image must be the same. For a feature that is observable in all of the images, a fixed scale length can be imposed to correct all ranges, such as described above. If the accuracy of any range is unknown, then a common range (scale) from one image, or an intermediate range, can be used on the other images. Note that if the size of the observed object is known, that size information can be used to independently determine the range of each image.

### Monoscopic Exploitation

Once the sensor model is solved, photogrammetric and computer vision techniques can be used to measure the object in the image. For a single image, such as shown in FIG. 4, the sensor model transforms 3-D coordinates into 2-D coordinates, which is a surjection where each 2-D output is projected to by multiple 3-D inputs.

The set of 3-D points (coordinates) in object space that project into a specific 2-D pixel coordinate is defined as the locus of that pixel. The locus of a pixel is a linear ray that extends from the focal plane at that pixel. The locus intersects with any plane in object space, such as a horizontal plane at a specific value of object-space Z. An assumption is that certain features of the object are linear/planar as they appear and perpendicular. Thus, for planar surfaces that are in the principal axes, pixel loci can be intersected with the principal planes to determine object-space coordinates. For example, for an extent that lies in an X-Y plane, the pixel coordinates of the observed endpoints can be projected out of the camera to image rays. If the Z coordinate of the plane is known, the image rays can be intersected with the specific plane to determine the 3-D coordinates of the endpoints of the object. If the Z coordinate is not known, the image coordinates can at least be projected onto the Z=0 plane and the distance between the coordinates can be calculated. This is because, at long range, image rays within the image are nearly parallel, and therefore the distance resulting from intersecting with a plane that is near Z=0 is insignificant.

Monoscopic exploitation is useful for any line observed to be in a principal plane, regardless of the orientation of the line. For lines that are observed to be parallel to a principal axis, the lengths of the lines along that axis can be determined. For instance, if two points on a vertical edge, which is parallel to the Z axis, are observed, then the height of the feature can be measured. The 3-D location of one endpoint can be situated on the Z=0 plane, e.g., at object-space position (X₀, Y₀, 0). Then the image ray projecting from the other endpoint can be intersected with the vertical ray (X₀, Y₀, 0)→(X₀, Y₀, 1) to determine the location of the other end point in object-space.

### Stereoscopic Exploitation

If two or more images of the same object are available and sensor models can be determined for all of the images, then stereo-/multi-scopic exploitation can be used to determine the 3-D coordinates of any point observable in multiple images. For proper alignment between sensor models, a common origin and scale must be used. If a point is observed in two images, the 3-D location of the point is the intersection (or approximate intersection) of the image rays projecting out of the two respective cameras from the observed pixels. The 3-D location can be taken to be the least-squares solution for the point closest to all of the image rays, or, for two images, the midpoint of the closest approach of the two image rays. With the object-space coordinates of a point observable in multiple images, 3-D reconstruction of the observable portions of the object can be obtained.

### 3D Modeling Methodology

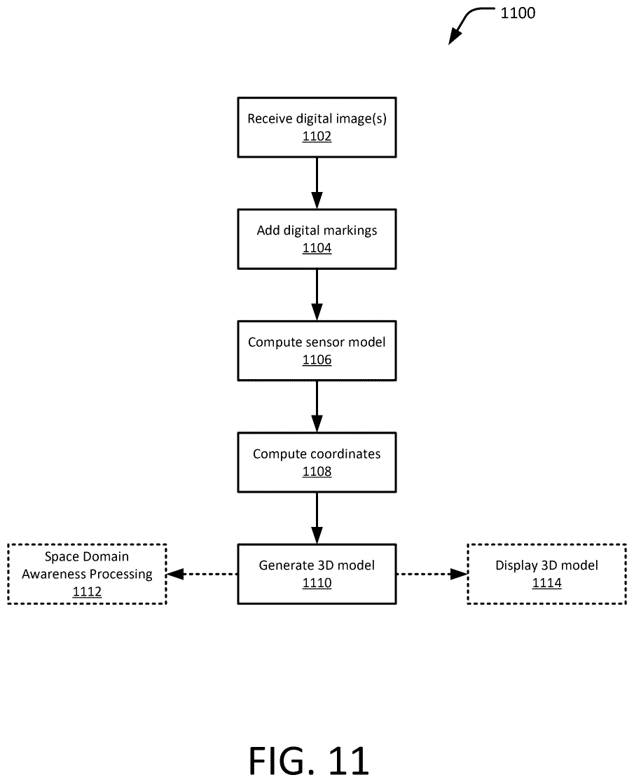

FIG. 11 is a flow diagram of a method 1100 of modeling three-dimensional objects from two-dimensional imagery, in accordance with an example of the present disclosure. The method 1100 can be used to improve the accuracy of space-based imagery, which in turn can be used for three-dimensional modeling of observable objects in space. The method 1100 includes receiving 1102, by one or more processors and from an imaging device, one or more digital images of an object and image data representing a focal length of the at least one image, a pixel size of the at least one image, and a range of the at least one image. The method 1100 further includes adding 1104, to the one or more digital images, digital markings each representing different features of the object. The markings are each perpendicular to a three-dimensional axis associated with the object. By orienting the markings to the axes associated with the object, the same features of the object appearing in two or more images (e.g., from different perspectives) can be aligned with a common coordinate system. The method 1100 further includes computing 1106, by the one or more processors, at least one sensor model of the imaging device based on the image data, the digital markings, and the three-dimensional axis associated with the object. For example, the sensor model can be computed such as described above with reference to FIGS. 4-10.

The method 1100 further includes computing 1108, by the one or more processors, object-space coordinates of points corresponding to at least one of the different features of the object based on the at least one sensor model. For example, the object-space coordinates correspond to the feature markings on the digital images as determined according to the sensor model for the corresponding image. The method 1100 further includes generating 1110, by the one or more processors, a three-dimensional model of the object based on the object-space coordinates of the points. The 3-D model can then be used for further processing 1112, such as for Space Domain Awareness. This capability enables measuring observable features of a space-based object from one or more digital images, and determining three-dimensional coordinates of various points on the surface of the object for building a three-dimensional model of the object. Using such a model, inferences about the capability of the object (e.g., a communications capability of the object based on the size of a solar panel, or the size or pointing of a radar dish, etc.).

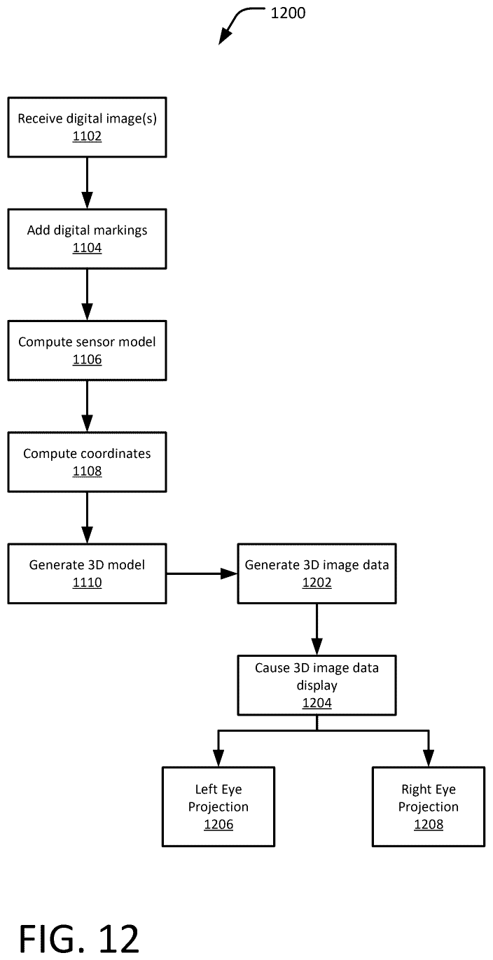

FIG. 12 is a flow diagram of a method 1200 of modeling three-dimensional objects from two-dimensional imagery, in accordance with an example of the present disclosure. The method 1200 is similar to the method 1100 of FIG. 11, further including generating 1202 three-dimensional image data of the object based on the three-dimensional model of the object, and causing 1204 the three-dimensional image data of the object to be displayed on a display device. For example, the solution to the camera matrix can be converted to an equivalent camera position and Euler angles, as well as the known focal length and pixel size of the camera, and the center-of-image principal point. Such data can be exploited, for example, using algorithms designed to handle blocks of airborne frame imagery or to generate an electronic light table for monoscopic and/or stereoscopic display 1114 using left and right eye image projectors 1206, 1208, which allows the human vision system to see details on the object that are not apparent in two or more separate two-dimensional images.

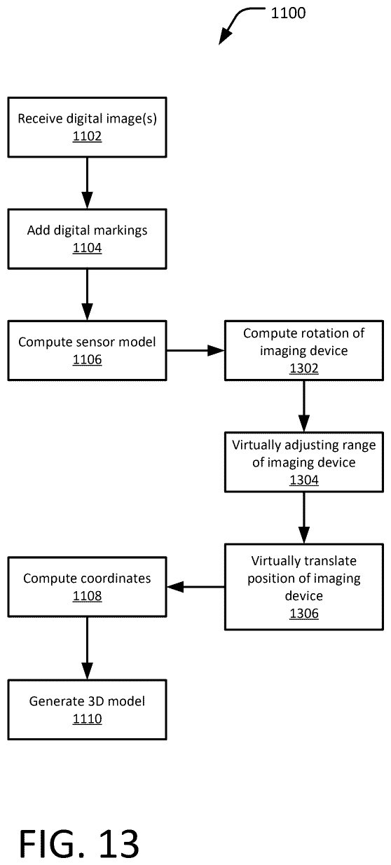

FIG. 13 is a flow diagram of the method 1100 of FIG. 11, where computing the at least one sensor model 1106 includes computing 1302, by the one or more processors, a rotation of the imaging device based on slopes of each the three-dimensional axis associated with the object with respect to a perspective in the one or more digital images, and where computing the at least one sensor model 1106 further includes virtually adjusting 1304, by the one or more processors, a range of the imaging device with respect to the object, and virtually translating 1306, by the one or more processors, a position of the imaging device parallel to a focal plane to align a user-selected origin within the one or more digital images with an origin of the three-dimensional axis associated with the object.

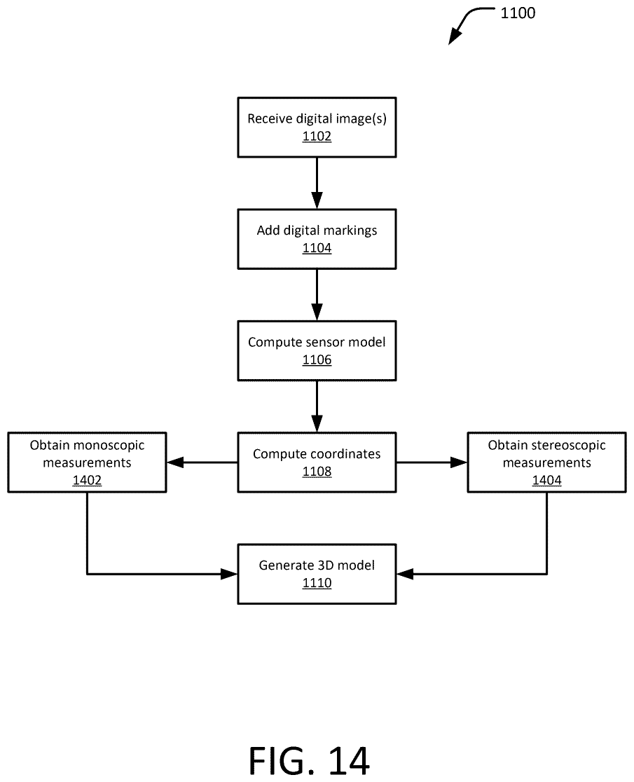

FIG. 14 is a flow diagram of the method 1100 of FIG. 11, where computing 1108 the object-space coordinates of the points corresponding to the at least one of the different features of the object includes obtaining 1402, by the one or more processors, monoscopic measurements of each of the different features of the object using the one or more digital images and the at least one sensor model. In some other examples, computing 1108 the object-space coordinates of the points corresponding to the at least one of the different features of the object includes obtaining 1404, by the one or more processors, stereoscopic measurements of each of the different features of the object using at least two of the one or more digital images and the at least one sensor model.

Some examples can be implemented, for example, using a machine readable medium or article that stores a set of instructions that, when executed by a machine, causes the machine to perform a method, process, and/or operations in accordance with the examples described herein. Such a machine can include, for example, any suitable processing platform, computing platform, computing device, processing device, computing system, processing system, computer, process, or the like, and can be implemented using any suitable combination of hardware and/or software. The machine readable medium or article can include, for example, any suitable type of memory unit, memory device, memory article, memory medium, storage device, storage article, storage medium, and/or storage unit, such as memory, removable or non-removable media, erasable or non-erasable media, writeable or rewriteable media, digital or analog media, hard disk, floppy disk, compact disk read only memory (CD-ROM), compact disk recordable (CD-R) memory, compact disk rewriteable (CD-RW) memory, optical disk, magnetic media, magneto-optical media, removable memory cards or disks, various types of digital versatile disk (DVD), a tape, a cassette, or the like. The instructions can include any suitable type of code, such as source code, compiled code, interpreted code, executable code, static code, dynamic code, encrypted code, and the like, implemented using any suitable high level, low level, object oriented, visual, compiled, and/or interpreted programming language.

Unless specifically stated otherwise, it will be appreciated that terms such as “processing,” “computing,” “calculating,” and “determining” refer to the action and/or process of a computer or computing system, or similar electronic computing device, that manipulates and/or transforms data represented as physical quantities (for example, electronic) within the registers and/or memory units of the computer system into other data similarly represented as physical entities within the registers, memory units, or other such information storage transmission or displays of the computer system.

The terms “circuit” or “circuitry” can include, for example, hardwired circuitry, programmable circuitry, such as computer processors comprising one or more individual instruction processing cores, state machine circuitry, and/or firmware that stores instructions executed by programmable circuitry. The circuitry can include a processor and/or controller configured to execute one or more instructions to perform one or more operations described herein. The instructions can be implemented as, for example, an application, software, firmware, etc., configured to cause the circuit or circuitry to perform any of the operations or functions described herein. Software can be implemented as a software package, code, instructions, instruction sets and/or data recorded on a computer-readable storage device. Software can be implemented to include any number of processes, and processes, in turn, can be implemented to include any number of threads, etc., in a hierarchical fashion. Firmware can be implemented as code, instructions or instruction sets and/or data that are hard-coded (e.g., nonvolatile) in memory devices. The circuit or circuitry can be implemented as part of a larger system, for example, an integrated circuit (IC), an application-specific integrated circuit (ASIC), a system-on-a-chip (SoC), desktop computers, laptop computers, tablet computers, servers, smartphones, etc. Other examples can be implemented as software executed by a programmable control device. In such cases, the terms “circuit” or “circuitry” are intended to include a combination of software and hardware such as a programmable control device or a processor capable of executing the software. As described herein, various examples can be implemented using hardware elements, software elements, or any combination thereof. Examples of hardware elements can include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, and/or chip sets.

### FURTHER EXAMPLE EXAMPLES

The following examples pertain to further examples, from which numerous permutations and configurations will be apparent.

Example 1 provides a method of modeling three-dimensional objects from two-dimensional imagery, the method comprising: receiving, by one or more processors and from an imaging device with a sensor, one or more digital images of an object and image metadata representing a focal length of the sensor, a pixel size of the sensor, and a range of each of the one or more digital images; adding, to the one or more digital images, digital markings representing perpendicular axes of the object; computing, by the one or more processors, at least one sensor model of the imaging device based on the image metadata, the digital markings, and the perpendicular axes of the object; computing, by the one or more processors, object-space coordinates of points corresponding to different features of the object based on the at least one sensor model; and generating, by the one or more processors, a three-dimensional model of the object based on the object-space coordinates of the points.

Example 2 include the subject matter of Example 1, further comprising generating three-dimensional image data of the object based on the three-dimensional model of the object, and causing the three-dimensional image data of the object to be displayed on a display device.

Example 3 includes the subject matter of Examples 1 or 2, wherein computing the at least one sensor model includes computing, by the one or more processors, a rotation of the imaging device based on slopes of each the perpendicular axes of the object with respect to a perspective in the one or more digital images.

Example 4 includes the subject matter of Example 3, wherein computing the at least one sensor model further includes virtually adjusting, by the one or more processors, a range of the imaging device with respect to the object; and virtually translating, by the one or more processors, a position of the imaging device parallel to a focal plane to align a user-selected origin within the one or more digital images with an origin of the perpendicular axes of the object.

Example 5 includes the subject matter of any one of Examples 1-4, wherein computing the object-space coordinates of the points corresponding to the different features of the object includes obtaining, by the one or more processors, monoscopic measurements of each of the different features of the object using the one or more digital images and the at least one sensor model.

Example 6 includes the subject matter of any one of Examples 1-5, wherein computing the object-space coordinates of the points corresponding to the different features of the object includes obtaining, by the one or more processors, stereoscopic measurements of each of the different features of the object using at least two of the one or more digital images and the at least one sensor model.

Example 7 provides a photogrammetry system for modeling three-dimensional objects from two-dimensional imagery, the system comprising: one or more processors configured to receive, from an imaging device with a sensor, a signal representing one or more digital images of an object; generate, based on the signal received from the imaging device, image metadata representing a focal length of the sensor, a pixel size of the sensor, and a range of each of the one or more digital images; add, to the one or more digital images, digital markings representing perpendicular axes of the object; compute at least one sensor model of the imaging device based on the image metadata, the digital markings, and the perpendicular axes of the object; compute object-space coordinates of points corresponding to different features of the object based on the at least one sensor model; and generate a three-dimensional model of the object based on the object-space coordinates of the points.

Example 8 includes the subject matter of Example 7, wherein the one or more processors is further configured to generate three-dimensional image data of the object based on the three-dimensional model of the object, and cause the three-dimensional image data of the object to be displayed on a display device.

Example 9 includes the subject matter of Examples 7 or 8, wherein computing the at least one sensor model includes computing, by the one or more processors, a rotation of the imaging device based on slopes of each the perpendicular axes of the object with respect to a perspective in the one or more digital images.

Example 10 includes the subject matter of Example 9, wherein computing the at least one sensor model further includes virtually adjusting, by the one or more processors, a range of the imaging device with respect to the object; and virtually translating, by the one or more processors, a position of the imaging device parallel to a focal plane to align a user-selected origin within the one or more digital images with an origin of the perpendicular axes of the object.

Example 11 includes the subject matter of any one of Examples 7-10, wherein computing the object-space coordinates of the points corresponding to the different features of the object includes obtaining, by the one or more processors, monoscopic measurements of each of the different features of the object using the one or more digital images and the at least one sensor model.

Example 12 includes the subject matter of any one of Examples 7-11, wherein computing the object-space coordinates of the points corresponding to the different features of the object includes obtaining, by the one or more processors, stereoscopic measurements of each of the different features of the object using at least two of the one or more digital images and the at least one sensor model.\

Example 13 includes the subject matter of any one of Examples 7-12, further comprising a communications device configured to transmit the signal.

Example 14 includes the subject matter of any one of Examples 7-13, wherein the imaging device is located on a satellite.

Example 15 includes the subject matter of any one of Examples 7-14, wherein the one or more processors is further configured to receive, from at least two imaging devices, signals representing two or more digital images of the object; and generate two or more digital images of the object based on the signals received from the at least two imaging devices.

Example 16 provides a method of modeling three-dimensional objects from two-dimensional imagery, the method comprising: receiving, by one or more processors and from at least two imaging devices each having a sensor, two or more digital images of an object and image metadata representing a focal length of each sensor, a pixel size of each sensor, and a range of each of the two or more digital images; adding, to the two or more digital images, digital markings representing perpendicular axes of the object; computing, by the one or more processors, at least two sensor models of the two or more imaging devices based on the image metadata, the digital markings, and the perpendicular axes of the object; computing, by the one or more processors, object-space coordinates of points corresponding to different features of the object based on the at least two sensor models; and generating, by the one or more processors, a three-dimensional model of the object based on the object-space coordinates of the points.

Example 17 includes the subject matter of Example 16, further comprising generating three-dimensional image data of the object based on the three-dimensional model of the object, and causing the three-dimensional image data of the object to be displayed on a display device.

Example 18 includes the subject matter of Examples 16 or 17, wherein computing the at least two sensor models includes computing, by the one or more processors, a rotation of each of the at least two imaging devices based on slopes of each the perpendicular axes of the object with respect to a perspective in the two or more digital images.

Example 19 includes the subject matter of Example 18, wherein computing the at least one sensor model further includes virtually adjusting, by the one or more processors, a range of each of the at least two imaging devices with respect to the object; and virtually translating, by the one or more processors, a position of each of the at least two imaging devices parallel to a focal plane to align a user-selected origin within the two or more digital images with an origin of the perpendicular axes of the object.

Example 20 includes the subject matter of any one of Examples 16-19, wherein computing the object-space coordinates of the points corresponding to the different features of the object includes obtaining, by the one or more processors, stereoscopic measurements of each of the different features of the object using at least two of the two or more digital images and the at least two sensor models.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be appreciated in light of this disclosure. The present disclosure should, therefore, be considered to encompass such combinations, variations, and modifications. It is intended that the scope of the present disclosure be limited not by this detailed description, but rather by the claims appended hereto. Future filed applications claiming priority to this application may claim the disclosed subject matter in a different manner and may generally include any set of one or more elements as variously disclosed or otherwise demonstrated herein.

What is claimed is:

1. A method of modeling three-dimensional objects from two-dimensional imagery, the method comprising:
receiving, by one or more processors and from an imaging device with a sensor, one or more digital images of an object and image metadata representing a focal length of the sensor, a pixel size of the sensor, and a range of each of the one or more digital images;
adding, to the one or more digital images, digital markings representing perpendicular axes of the object;
computing, by the one or more processors, at least one sensor model of the imaging device based on the image metadata, the digital markings, and the perpendicular axes of the object;
computing, by the one or more processors, object-space coordinates of points corresponding to different features of the object based on the at least one sensor model; and
generating, by the one or more processors, a three-dimensional model of the object based on the object-space coordinates of the points.

2. The method of claim 1, further comprising generating three-dimensional image data of the object based on the three-dimensional model of the object, and causing the three-dimensional image data of the object to be displayed on a display device.

3. The method of claim 1, wherein computing the at least one sensor model includes
computing, by the one or more processors, a rotation of the imaging device based on slopes of each the perpendicular axes of the object with respect to a perspective in the one or more digital images.

4. The method of claim 3, wherein computing the at least one sensor model further includes
virtually adjusting, by the one or more processors, a range of the imaging device with respect to the object; and
virtually translating, by the one or more processors, a position of the imaging device parallel to a focal plane to align a user-selected origin within the one or more digital images with an origin of the perpendicular axes of the object.

5. The method of claim 1, wherein computing the object-space coordinates of the points corresponding to the different features of the object includes obtaining, by the one or more processors, monoscopic measurements of each of the different features of the object using the one or more digital images and the at least one sensor model.

6. The method of claim 1, wherein computing the object-space coordinates of the points corresponding to the different features of the object includes obtaining, by the one or more processors, stereoscopic measurements of each of the different features of the object using at least two of the one or more digital images and the at least one sensor model.

7. A photogrammetry system for modeling three-dimensional objects from two-dimensional imagery, the system comprising:
one or more processors configured to
receive, from an imaging device with a sensor, a signal representing one or more digital images of an object;
generate, based on the signal received from the imaging device, image metadata representing a focal length of the sensor, a pixel size of the sensor, and a range of each of the one or more digital images;
add, to the one or more digital images, digital markings representing perpendicular axes of the object;
compute at least one sensor model of the imaging device based on the image metadata, the digital markings, and the perpendicular axes of the object;
compute object-space coordinates of points corresponding to different features of the object based on the at least one sensor model; and
generate a three-dimensional model of the object based on the object-space coordinates of the points.

8. The system of claim 7, wherein the one or more processors is further configured to generate three-dimensional image data of the object based on the three-dimensional model of the object, and cause the three-dimensional image data of the object to be displayed on a display device.

9. The system of claim 7, wherein computing the at least one sensor model includes
computing, by the one or more processors, a rotation of the imaging device based on slopes of each the perpendicular axes of the object with respect to a perspective in the one or more digital images.

10. The system of claim 9, wherein computing the at least one sensor model further includes
virtually adjusting, by the one or more processors, a range of the imaging device with respect to the object; and
virtually translating, by the one or more processors, a position of the imaging device parallel to a focal plane to align a user-selected origin within the one or more digital images with an origin of the perpendicular axes of the object.

11. The system of claim 7, wherein computing the object-space coordinates of the points corresponding to the different features of the object includes obtaining, by the one or more processors, monoscopic measurements of each of the different features of the object using the one or more digital images and the at least one sensor model.

12. The system of claim 7, wherein computing the object-space coordinates of the points corresponding to the different features of the object includes obtaining, by the one or more processors, stereoscopic measurements of each of the different features of the object using at least two of the one or more digital images and the at least one sensor model.

13. The system of claim 7, further comprising a communications device configured to transmit the signal.

14. The system of claim 7, wherein the imaging device is located on a satellite.

15. The system of claim 7, wherein the one or more processors is further configured to
receive, from at least two imaging devices, signals representing two or more digital images of the object; and
generate two or more digital images of the object based on the signals received from the at least two imaging devices.

16. A method of modeling three-dimensional objects from two-dimensional imagery, the method comprising:
receiving, by one or more processors and from at least two imaging devices each having a sensor, two or more digital images of an object and image metadata representing a focal length of each sensor, a pixel size of each sensor, and a range of each of the two or more digital images;
adding, to the two or more digital images, digital markings representing perpendicular axes of the object;
computing, by the one or more processors, at least two sensor models of the two or more imaging devices based on the image metadata, the digital markings, and the perpendicular axes of the object;
computing, by the one or more processors, object-space coordinates of points corresponding to different features of the object based on the at least two sensor models; and
generating, by the one or more processors, a three-dimensional model of the object based on the object-space coordinates of the points.

17. The method of claim 16, further comprising generating three-dimensional image data of the object based on the three-dimensional model of the object, and causing the three-dimensional image data of the object to be displayed on a display device.

18. The method of claim 16, wherein computing the at least two sensor models includes
computing, by the one or more processors, a rotation of each of the at least two imaging devices based on slopes of each the perpendicular axes of the object with respect to a perspective in the two or more digital images.

19. The method of claim 18, wherein computing the at least one sensor model further includes
virtually adjusting, by the one or more processors, a range of each of the at least two imaging devices with respect to the object; and
virtually translating, by the one or more processors, a position of each of the at least two imaging devices parallel to a focal plane to align a user-selected origin within the two or more digital images with an origin of the perpendicular axes of the object.

20. The method of claim 16, wherein computing the object-space coordinates of the points corresponding to the different features of the object includes obtaining, by the one or more processors, stereoscopic measurements of each of the different features of the object using at least two of the two or more digital images and the at least two sensor models.
